(19) United States
(12) Patent Application Publication
(10) Pub. No.: US 2010/0024898 A1
(43) Pub. Date: Feb. 4, 2010

(54) FUEL TANK VENT INCLUDING A MEMBRANE SEPARATOR

(75) Inventors: Vishal Bansal, Overland Park, KS (US); Nusrat Farzana, Lee's Summit, MO (US)

Correspondence Address: CANTOR COLBURN, LLP, 20 Church Street, 22nd Floor, Hartford, CT, 06103, US

(73) Assignee: GENERAL ELECTRIC COMPANY, Schenectady, NY (US)

(21) Appl. No.: 12/181,378

(22) Filed: Jul. 29, 2008

(51) Int. Cl. B01D 53/22; F16K 24/04; B65D 25/38

(52) U.S. Cl. 137/197; 96/6; 137/587; 977/781; 977/902

(57) ABSTRACT

A fuel tank vent includes a nanoporous membrane separator positioned in an opening in a fuel tank to allow vapor from a fuel to flow across a membrane, wherein the membrane comprises a network in which surfaces of the network define a plurality of interconnecting pores extending through the membrane, wherein the plurality of interconnecting pores have a mean pore size of about 0.1 nanometers to about 50 nanometers, and are permeable to a selected one or both of the fuel vapor and air, and impermeable to a liquid fuel; and an oleophobic enhancement coating disposed on surfaces of the plurality of interconnecting pores and configured to provide oleophobicity to the membrane.

### BACKGROUND OF THE INVENTION

The present disclosure relates generally to a vent for the fuel tanks of internal combustion engines and, more specifically, to fuel tank vents having an oleophobically-treated membrane separator.

Combustion engines, such as small internal combustion engines,, and the like for machines, such as lawn mowers, garden tractors, power saws, power generators, and the like, generally require a fuel tank for their operation. The fuels used; such as ethanol, methanol, gasoline, diesel fuel, kerosene, and the like, naturally have, under standard conditions, a high vapor pressure. Fuel vapors, increased by mixing of the liquid fuel or by warming thereof, can be formed in the tank systems. The fuel vapors can exert a pressure on the tank systems and the fuel system. Appropriate pressure compensations are therefore desired for the tank and fuel systems.

Pressure compensation can be achieved by venting of the tank and/or fuel system. A vent to the atmosphere disposed in the fuel tank can aid in relieving the pressure. The vent can be incorporated into the fuel cap itself, or it can be a separate opening in the tank.

Pressure compensation can also be achieved via a venting system, in which various floats and siphons separate the liquid fuel from a vapor, in order to prevent liquid fuel from escaping the tank. Current legislation on the release of emissions from fuel tanks in certain applications can restrict the escape of fuel vapors from the tank system into the environment, in particular for fuels of internal combustion engines in motor vehicles. Accordingly, the venting system in motor vehicles is generally implemented as a closed system. Such systems can be replicated in small combustion engines as well (e.g., lawn mowers and the like). An adsorption section can follow the venting system of the fuel tank system. Such an adsorption section comprises a fuel adsorber, which binds the escaping vapors.

For the above described pressure compensation systems, the simple vent or vented fuel cap, or the entirely separate venting system, the use of a porous metal separator is generally used to allow air and/or fuel vapor to escape from the fuel tank, without permitting the liquid fuel to flow therethrough. If the liquid fuel comes in contact with the porous metal, the metal can quickly become saturated with the fuel. When the porous metal is overloaded with the fuel, its effectiveness as a separator is reduced. Moreover, the porous metal separator vent is generally comprised of an expensive metal. The cost associated therewith is not economical for small engine systems, such as lawn mowers, power saws, and the like.

### SUMMARY OF THE INVENTION

Disclosed herein are fuel tank vents and vent systems particularly suitable for small combustion engines. According to an embodiment, a fuel tank vent includes a nanoporous membrane separator positioned in an opening in a fuel tank to allow vapor from a fuel to flow across a membrane, wherein the membrane comprises a network in which surfaces of the network define a plurality of interconnecting pores extending through the membrane, wherein the plurality of interconnecting pores have a mean pore size of about 0.1 nanometers to about 50 nanometers, and are permeable to a selected one or both of the fuel vapor and air, and impermeable to a liquid fuel; and an oleophobic enhancement coating disposed on surfaces of the plurality of interconnecting pores and configured to provide oleophobicity to the membrane.

In another embodiment, a fuel tank system for storing and providing fuel to a small combustion engine is disclosed. The system includes a fuel tank configured to hold a liquid fuel, comprising an opening for filling the tank; and a fuel cap configured to close the opening of the fuel tank, wherein the fuel cap comprises a main body portion having a vent aperture formed therein; a nanoporous membrane separator disposed in the main body portion and in fluid communication with the vent aperture, wherein the nanoporous membrane separator comprises a membrane, and the membrane comprises a network in which surfaces of the network define a plurality of interconnecting pores extending through the membrane, wherein the plurality of interconnecting pores have a mean pore size of about 0.1 nanometers to about 50 nanometers, and are permeable to a selected one or both of a fuel vapor and air, and impermeable to a liquid fuel; and an oleophobic enhancement coating disposed on surfaces of the plurality of interconnecting pores and configured to provide oleophobicity to the membrane.

In still another embodiment, another fuel tank system for storing and providing fuel to a small combustion engine is disclosed. This system includes a fuel tank configured to hold a liquid fuel, comprising an opening for filling the tank; a fuel cap configured to close the opening of the fuel tank; and a venting system disposed remote from the fuel cap in a second opening of the fuel tank, wherein the venting system is configured to provide pressure compensation to the fuel tank. The system includes a housing defining a chamber in fluid communication with the second opening; a cover disposed over and in physical communication with the housing; a nanoporous membrane separator disposed in the housing and in fluid communication with the chamber, wherein the nanoporous membrane separator comprises a membrane, and the membrane comprises a network in which surfaces of the network define a plurality of interconnecting pores extending through the membrane, wherein the plurality of interconnecting pores have a mean pore size of about 0.1 nanometers to about 50 nanometers, and are permeable to a selected one or both of a fuel vapor and air, and impermeable to a liquid fuel; and an oleophobic enhancement coating disposed on surfaces of the plurality of interconnecting pores and configured to provide oleophobicity to the membrane.

The above described and other features are exemplified by the following Figures and detailed description.

### BRIEF DESCRIPTION OF THE DRAWINGS

Referring now to the Figures, which are exemplary embodiments, and wherein the like elements are numbered alike:

FIG. 1 is a schematic illustration of fuel tank system having a vented membrane separator fuel cap;

FIG. 2 is an exploded assembly view of the vented membrane separator fuel cap of FIG. 1;

FIG. 3 is a schematic illustration of a fuel tank system having a fuel cap and a venting system including a membrane separator; and

FIG. 4 is an exploded assembly view of the venting system and membrane separator of FIG. 3.

### DETAILED DESCRIPTION OF THE INVENTION

The fuel tank vents and vent systems described herein include an oleophobically-treated nanoporous membrane separator. As used herein, the term “nanoporous” refers to a membrane separator having a mean pore size of about 0.1 nanometers (nm) to about 50 nm. The oleophobic treatment on the membrane separator can increase the fuel repellency of the membrane separator and allow the fuel tank vent to be effective even as a roll-over vent in small engine applications. The oleophobic treatment, moreover, can increase the operating life of the membrane separator by helping to prevent the overloading or saturation of the vent by the liquid fuel, particularly when the engine tips over. The treatment prevents saturation of the membrane, thereby allowing vapor/air to pass and preventing the liquid fuel through, even when the fuel is in direct contact with the membrane. The nanoporous membrane separator as described herein comprises materials that are advantageously less expensive than the porous metal separators currently used in fuel tank venting applications. In an exemplary embodiment, the nanoporous membrane separator comprises a cellulose acetate membrane. The fuel tank vent and vent systems described herein can be disposed in any small combustion engine application, such as, without limitation, lawn mowers, garden tractors, power saws, power generators, and the like.

As mentioned, the membrane separator comprises an oleophobically-treated nanoporous membrane disposed in a fuel tank vent or venting system to provide pressure compensation in a fuel tank system. The oleophobic membrane separator is very poorly wetted by the liquid fuel in the tank. The nanoporous nature of the membrane only permits the liquid fuel to pass through under extremely high tank pressures. Advantageously, simple separation of the liquid fuel and the fuel vapors is thereby made possible, and pressure compensation in the fuel tank system can be achieved. The nanoporous membrane separator, therefore, is suitable for a component of a tank vent to separate fuel vapor from the fuel itself. The fuel vapor and air, however, can diffuse through the nano-sized pores in the membrane.

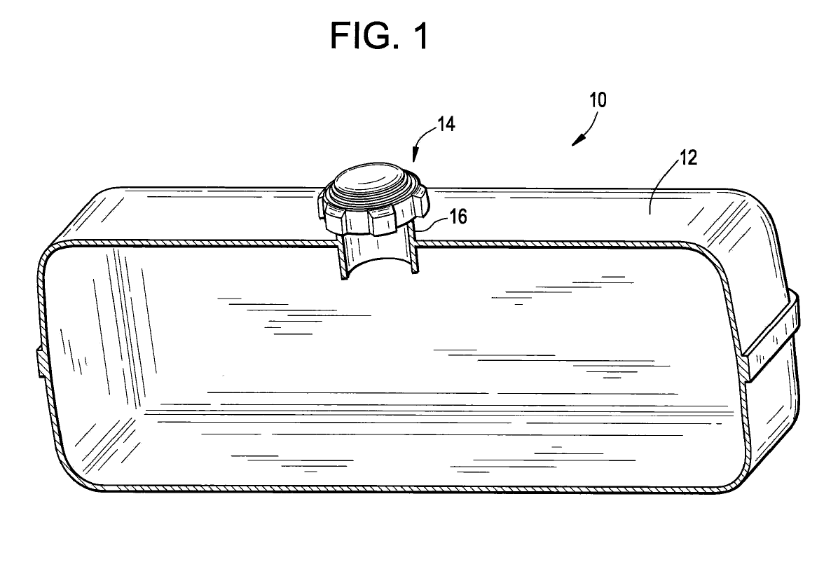

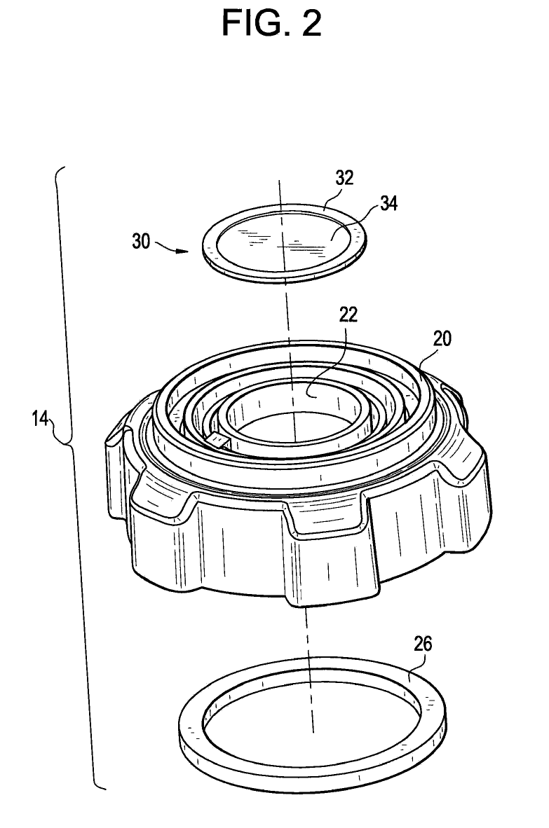

FIGS. 1-4 illustrate a fuel tank system 10 and components thereof comprising a nanoporous membrane separator. As shown in FIG. 1, the system 10 includes the fuel tank 12 and a cap 14 for closing and opening the tank. In this embodiment, the cap 14 can serve as the venting structure, which can allow the passage of air and fuel vapor out of the fuel tank 12. The vented cap 14 comprises the nanoporous membrane separator therein. FIG. 2 illustrates an exemplary embodiment of the cap 14. The cap 14 can have a main body portion 20 having a venting aperture 22 formed therein. The main body portion 20 is configured to include threads for engaging and opening the cap 14. A gasket 26 can also be included in the cap 14, and is configured to form a circumferential seal between the cap 14 and the opening 16 in the fuel tank 12. A nanoporous membrane separator 30 is advantageously disposed in fluid communication with the venting aperture 22. The nanoporous membrane separator 30 can have a diameter that is greater than the diameter of the venting aperture 22, such that the membrane is supported by the main body portion 20. The nanoporous membrane separator 30 can further comprise a peripheral rim portion 32 to further support the membrane. The rim portion 32 can have a thickness greater than that of a central portion 34, and can be configured to be in physical communication with the cap main body portion 20, while the central portion 34 is in fluid communication with the venting aperture 22. As illustrated in this embodiment, the nanoporous membrane separator 30 is generally planar and disk-shaped. In other embodiments, the nanoporous membrane separator can have any shape suitable for pressure compensation in a fuel tank and will depend on, among other things, fuel tank design, fuel cap design, operating fuel pressure, and the like.

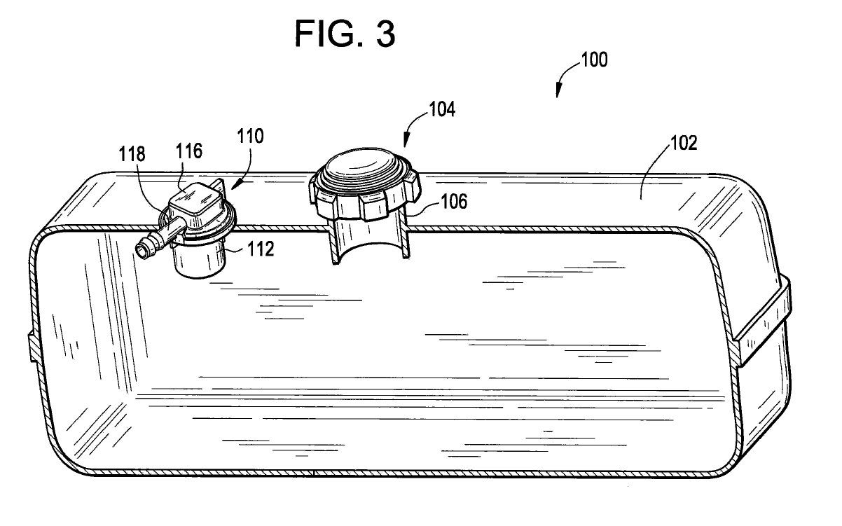

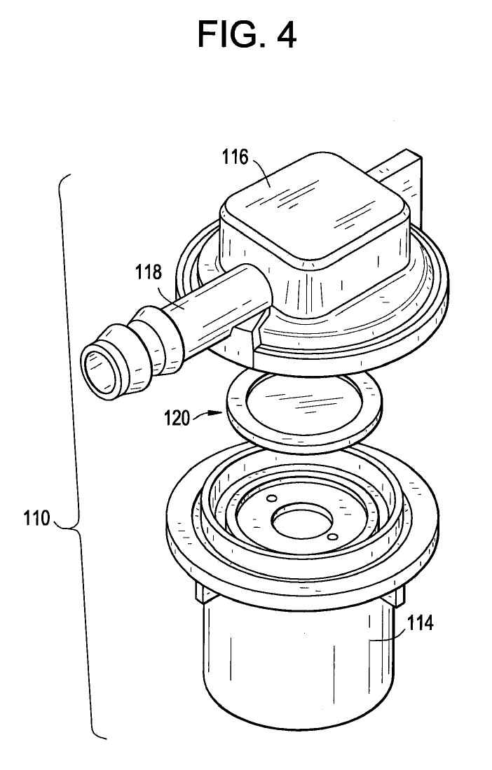

Turning now to FIG. 3, a fuel tank system 100 is illustrated. The fuel tank system 100 includes a fuel tank 102 and a remote venting system 110. A cap 104 is disposed over an opening 106 of the tank, and is configured to open and close permitting and/or preventing the flow of liquid fuel in and out of the tank. As illustrated in this embodiment, the cap 104 does not comprise a nanoporous membrane separator for venting the system 100. However, in other embodiments, the cap could provide pressure compensation to the system along with the venting system 110. The venting system 110 comprises the nanoporous membrane separator, and is configured to provide pressure compensation to the fuel tank system 100. The venting system 110 is disposed in a second opening 112 remote from the cap 104. As shown in FIG. 4, the venting system 110 can include a housing 114 and a cover 116. The cover 116 can include a port 118, which may be connected to a tube, hose, or other conduit for directing the fuel vapor to a storage canister, preventing the fuel vapor from escaping to the atmosphere. The nanoporous membrane separator 120 can be disposed between the housing 114 and the cover 116. The housing 114 defines a path from the fuel tank 102 to the port 118 in the cover 116. The nanoporous membrane separator 120 is positioned in the flow path between the interior of the housing 114 and the port 118 in the cover 116. Accordingly, for any air, fuel vapor, and/or liquid fuel to exit from the fuel storage system 100, it must pass through the nanoporous membrane separator 120. As shown in FIG. 4, the membrane 120 can have a shape substantially similar to that of FIG. 2. In another embodiment, the nanoporous membrane separator 120 can have a different shape.

The membrane 120 can be removeably disposed in the vent housing 114, or it can be permanently fixed within the housing. Exemplary methods/structures for constructing the fuel tank vent or venting systems can include for example, without limitation, adhesives, molding, sandwiching between adjacent parts, and the like to mount or join the membrane to the main body portion 20 or vent housing 114. Again, the fuel tank cap 10 or venting system 100 can be employed in various applications including different styles of vents (e.g., cap, remote rollover, etc.) different sizes, and the like. In some embodiments, the membrane separator can provide a fuel/vapor separation between a tank and a volatile organic compound canister or air cleaner.

When a fuel tank cap including the membrane separator is installed on the tank opening, make-up air is able to be drawn into the fuel tank and excess pressure in the fuel tank is able to be relieved. When the membrane separator is disposed in a venting system, excess pressure in the fuel tank can be relieved without releasing any substantial amount of fuel vapor to the outside atmosphere. This can be particularly beneficial to prevent exposure of an operator to any substantial amount of fuel vapor during operation (e.g., operating a lawn mower, using a chain saw, etc.).

The membrane separator comprises a nanoporous membrane and an oleophobic coating. The membrane comprises a material having a nanoporous structure that is permeable to fuel vapor and air, while being impermeable to the liquid fuel. To reiterate, the term “nanoporous” refers to a membrane separator having a mean pore size of about 0.1 nanometers (nm) to about 50 nm. In a specific embodiment, the mean pore size of the nanoporous membrane is in the range of about 1 nm to about 20 nm. The porosity of the nanoporous membrane can be in the range of about 50% to about 95%, specifically about 60% to about 80%, based on the total volume of the membrane. As is described in more detail below, the coating desirably is thin, and does not substantially affect the porosity of the membrane separator, i.e., the coated nanoporous membrane. However, in some embodiments, it is useful to select a nanoporous membrane having a slightly greater pore size and volume than is desired in the membrane separator, so as to compensate for any volume lost upon coating.

In some embodiments, thicknesses of the membrane in the fuel tank can be in a range of about 0.5 μm to about 500 μm. In exemplary embodiments, the thickness of the membrane can range from about 4 μm to about 200 μm, specifically from about 10 μm to about 150 μm, and more specifically from about 25 μm to about 100 μm. However, larger and smaller thicknesses can be used.

The nanoporous membrane can be manufactured from a variety of different, polymeric materials. Selection of the appropriate material will depend on factors such as durability, compatibility with the oleophobic coating, availability, cost, ease of manufacure, and like considerations. Polymeric materials can be specifically mentioned, and include, for example, polyolefins (e.g. polyethylene or polypropylene), polysulfones, polyethersulfones, polyvinylhalides, cellulosic materials (e.g., nitrocellulose, cellulose ethers, and cellulose esters such as cellulose acetate), polyamides (nylons), polyimides, polyetherimides, polyaramides, polybenzimidazoles, polyether ether ketones, poly(C₁₋₄)alkyl acrylates, poly(C₁₋₄)alkyl methacrylates, fluoropolymers (e.g., expanded polytetetrafluoroethylene), polystyrenes, polystyrene copolymers (e.g., polystyrene-polymethylmethacrylate), polyurethanes, polyesters, and the like.

In an exemplary embodiment, the nanoporous membrane separator comprises a cellulosic membrane, for example, without limitation, cellulose ethers, cellulose esters, and the like. In a specific exemplary embodiment, the nanoporous membrane separator comprises a cellulose acetate membrane. The cellulosic nanoporous membranes can be made by any suitable method, all of which are well known to those having skill in the art. In one embodiment, the cellulosic membrane is made by a process where a layer having a porosity effective to separate fuel and fuel vapor is formed at one surface of the membrane. This layer is sometimes termed the “active” layer and the membrane has increasing porosity proceeding in the direction through the membrane away from the “active” layer. This construction provides the membrane with the selectively porous nature. The selective nature of the nanoporous membrane separator can be dependent upon one or more critical manufacturing process elements such as, without limitation, the particular solvents used in the process, the presence or absence of certain inorganic and organic salts in the casting dope solvent systems, the particular way the membranes are “developed” from dopes that contain the essential materials, the particular treatment the resulting membranes receive after they are developed, and the like.

An exemplary process for manufacturing nanoporous cellulosic membranes can include casting a doping agent in the form of a thin film upon a casting web.

The nanoporous membrane separator further includes an oleophobic coating disposed thereon. “Oleophobicity” of the membrane can be rated on a scale of 1 to 8 according to AATCC test 118-1992, incorporated herein by reference. This test evaluates the membrane's resistance to wetting. Eight standard oils, labeled #1 to #8, are used in the test. The #1 oil is mineral oil (surface tension: 31.5 dyes/cm @25 degrees Celsius (° C.)) and the #8 oil is heptane (surface tension: 14.8 dynes/cm @25° C.). Five drops of each rated oil is placed on the membrane. Failure occurs when wetting of the membrane by a selected oil occurs within 30 seconds. The oleophobic rating of the membrane corresponds to the last oil successfully tested. The higher the oleophobic rating, the better the oleophobicity. After treatment, the membrane 10 can have an increased oleophobicity. In an exemplary embodiment, the oleophobicity of the membrane 10 is at least 1, specifically at least 2, more specifically at least 4, even more specifically at least 6, and most specifically at least 8.

The nanoporous membrane is treated using an oleophobic coating material, in one embodiment to increase the oleophobicity of the membrane. Exemplary oleophobic coating materials include fluorinated polymers, which as used herein includes homopolymers and copolymers having fluorohydrocarbon and/or a perfluorohydrocarbon moieties. The fluoro- or perfluorohydrocarbon moieties can be incorporated into the polymer backbone, pendant from the polymer backbone, or a combination thereof. Accordingly, a variety of different types of polymers can be used, including, for example, polyolefins, polyacrylates, polymethacrylates, polyesters, polysulfones, polyethersulfones, polycarbonates, polyethers, polyamides, polyacrylamides, polysulfonamides, polysiloxanes, and polyurethanes.

The fluorinated polymers can be derived from polymerization of a variety of monomers or oligomers known to produce the desired backbone ands that include fluorinated or perfluorinated C₁₋₃₂ hydrocarbon moieties, in particular fluoro(C₁₋₃₂)alkyl and/or perfluoro(C₁₋₃₂)alkyl moieties. In one embodiment, perfluoro(C₁₋₁₆)alkyl moieties are present, in particular, —CF₃, —CF₂CF₃, and —CF₂CF₂CF₃. In another embodiment, perfluoro(C₁₋₄)alkylene moieties are present, in particular, —CF₂—, —CF₂CF₂—, and —CF₂CF₂CF₂—. Exemplary monomer or oligomer units can include, for example, fluoro(C₁₋₁₆)alkyl acrylates, fluoro(C₁₋₁₆)alkyl methacrylates, perfluoro(C₁₋₁₆)alkyl acrylates, perfluoro(C₁₋₁₆)alkyl methacrylates, fluorinated and perfluorinated C₁₋₁₂ olefins such as, tetrafluoroethylene, fluoro(C₁₋₁₂)alkyl maleic acid esters, perfluoro(C₁₋₁₂)alkyl maleic acid esters, fluoro(C₁₋₁₂)alkyl (C₆₋₁₂)aryl urethane oligomers, fluoro(C₁₋₁₂)alkyl allyl urethane oligomers, fluoro(C₁₋₁₂)alkyl urethane acrylate oligomers, fluoro(C₁₋₁₂)alkyl urethane acrylate oligomers, and the like. The fluorinated monomers or oligomers can optionally be copolymerized with additional non-fluorinated monomers or oligomers including, for example, unsaturated hydrocarbons (e.g., olefins), (C₁₋₁₂)alkyl acrylates, and (C₁₋₁₂)alkyl methacrylates.

Specific exemplary classes of these oleophobic polymers include, without limitation, apolar perfluoroalkylpolyethers having —CF₃, —CF₂CF₃, and —CF₂CF₂CF₃moieties (PFPE), mixtures of apolar (PFPE) with polar monofunctional PFPE, polar water-insoluble PFPE with phosphate, silane, or amide end groups, mixtures of apolar PFPE with fluorinated or perfluorinated (C₁₋₁₂)alkyl methacrylate polymers or fluorinated or perfluorinated (C₁₋₁₂)alkyl acrylate polymers, and copolymers comprising perfluoro(C₁₋₃)alkylether units and fluorinated or perfluorinated (C₁₋₁₂)alkyl methacrylate units or fluorinated or perfluorinated (C₁₋₁₂)alkyl acrylate units. The above-mentioned polymers can be crosslinked by, for example, UV radiation in aqueous form solution or emulsion. Mixtures of the fluorinated polymers can be used as well.

The oleophobic polymers are commercially available as emulsions. Exemplary emulsions can include, without limitation, those based on copolymers of siloxanes and perfluoro(C₁₋₁₂)alkyl-substituted acrylates or methacrylates, emulsions based on fluorinated or perfluorinated co- or terpolymers, one type of unit containing at least hexafluoropropene or perfluoroalkyl vinyl ether, emulsions based on perfluoro(C₁₋₁₂)alkyl-substituted polyacrylates and methacrylates, and the like. These polymers and their preparation are well known to those with skill in the art. A specific oleophobic fluorinated polymer is a perfluoroalkyl acrylic copolymer and/or perfluoroalkyl methacrylic copolymer water-based dispersion of Zonyl® 8195, 7040, 8412, and/or 8300, available from Dupont of Wilmington, Del.

The nanoporous membrane separator is rendered oleophobic by treating it with an oleophobic coating composition. The process of treating the membrane can comprise any suitable method for oleophobically coating an article, and are well known to those skilled in the art. Exemplary techniques can include applying the oleophobic coating composition in a liquid form, e.g., a melt, or solution, or latex dispersion of the material. Exemplary methods for applying the liquid oleophobic coating composition can include, without limitation, dipping, painting, spraying, roller-coating, brushing, and the like, over the surface of the membrane. Regardless of the technique, the application can be carried out until internal surfaces of the nanoporous membrane structure are coated with the oleophobic coating composition, but not until the pores are filled as that could lessen the gas-liquid absorption property of the membrane. Thus, the presence of the oleophobic coating composition has little effect on the porosity; that is, the walls defining the voids in the nanoporous membrane have only a very thin coating of the oleophobic material. Application of the oleophobic coating composition can be achieved by varying the concentration, solids content of the solution or dispersion, and/or by varying the application temperature, or pressure

The use of an organic or inorganic solvent can help to facilitate the distribution of the oleophobic fluorinated polymer throughout the nanoporous membrane. Typically, the nanoporous membrane is not initially oleophobic and may be oleophilic. Thus, use of a solvent can sometimes reduce difficulties in wetting and/or saturating the membrane structure with the oleophobic coating composition. A variety of solvents can be used.

During application to the membrane, the oleophobic coating composition can wet and saturate the membrane. The oleophobic polymer is disposed on the membrane and can impart oleophobicity to the nanoporous membrane separator. It is possible in some embodiments to achieve covalent coupling between the oleophobic coating and the membrane. In an optional embodiment, the oleophobically-treated nanoporous membrane separator can be “cured” by heating. This “curing” process can possibly increase the oleophobicity by allowing rearrangement of the fluoropolymer into a specific oleophobic orientation. The application of heat can permit the oleophobic fluoropolymer to flow around the nodes and fibrils of the porous membrane to form the coating. The curing temperature can vary among the oleophobic fluoropolymers. Exemplary ranges can include from about 40° C. to about 140° C., specifically about 50° C. to about 130° C., and more specifically about 70° C. and about 125° C.

In a specific embodiment, the fluorinated polymer is in the form of a stabilized water-miscible dispersion of the polymer solids. In this embodiment, the oleophobic fluoropolymer solids can also contain relatively small amounts of acetone and ethylene glycol or other water-miscible solvents and surfactants that were used in the polymerization reaction when the fluorinated polymer solids were made. Optionally, the dispersion of oleophobic fluorinated polymer solids is stabilized with a stabilizing agent, such as, but not limited to, deionized and/or demineralized water. The stabilizing agent reduces the propensity of the oleophobic fluorinated polymer solids from settling out and agglomerating to a size, which cannot enter a pore in the membrane to be coated. Although the coating composition may include other amounts of stabilizing agent, in some embodiments the coating composition forming coating layer includes an amount of stabilizing agent in the range of about 5 wt % to 50 wt %. For example, in some embodiments the coating composition includes an amount of stabilizing agent in the range of about 15 wt % to about 25 wt %.

The stabilized dispersion of oleophobic fluorinated polymer solids can be diluted in one or more suitable solvents to form the coating composition that will form coating layer. Although other solvents may be used, suitable solvents can include, but are not limited to, water, ethanol, isopropyl alcohol, acetone, methanol, n-propanol, n-butanol, N,N-dimethylformamide, methyl ethyl ketone and water soluble e-and p-series glycol ethers. Moreover, although the solvents can have other surface tensions, in some embodiments, the coating composition includes a solvent having a surface tension of less than about 31 dynes per centimeter. After coating, as described above, the coating composition is then consolidated, for example by heating the coated membrane such that the oleophobic fluorinated polymer solids flow and coalesce, and such that the stabilizing agents and solvents are removed. During the application of heat, the thermal mobility of the oleophobic fluoropolymer solids allows the solids to be mobile and flow around, engage, and adhere to surfaces of the membrane, and therefore coalesce to form the coating layer.

Irrespective of the solvent or carrier used, the coating compositions can include an amount of oleophobic fluoropolymer solids in the range of about 0. 1 wt % to about 10 wt % based on a total weight of the coating composition. For example, in some embodiments, the coating composition includes oleophobic fluoropolymer solids in the range of about 0.5 wt % to about 1.5 wt %. When the coating composition includes other amounts of solvent, other than water, the coating composition that forms coating layer includes an amount of solvent, other than water, in the range of about 40 wt % to about 80 wt %. For example, in some embodiments the coating composition includes an amount of solvent, other than water, in the range of about 50 wt % to about 75 wt %.

The coating composition has a surface tension and a relative contact angle that enable the coating composition to wet pores in the membrane such that pores are coated with the oleophobic fluorinated polymer solids in the coating composition. However, in some embodiments where an organic solvent is used as described above, the membrane is wet with a solution containing a solvent before the coating composition is applied to membrane such that the coating composition will pass through membrane pores and “wet-out” surfaces of membrane.

The thickness of coating layer formed and the amount and type of fluorinated polymer solids in the coating layer can depend on several factors, including the affinity of the solids to adhere and conform to the surfaces of the membrane that define membrane pores, the final solids content within the coating composition, the coating process, and the intended use and desired durability during use.

It is not necessary that the coating composition completely encapsulate the entire surface of the membrane network, or be continuous to increase oleophobicity of the membrane. However, in one embodiment, at least 50%, specifically at least 75%, and more specifically at least 90% of the membrane surfaces are coated.

The oleophobically-treated nanoporous membrane separator can be advantageously employed in the opening of a fuel tank system to allow release of built-up fuel vapor in the tank, without allowing the liquid fuel to exit through the opening. The nanoporous membrane separator can be particularly useful in a fuel tank cap or venting system for the fuel tank of a small combustion engine. Along with pressure compensation, the nanoporous membrane separator can further provide a roll-over vent for the fuel tank, again allowing fuel vapor exit without permitting fuel leakage even when the engine undergoes a change in attitude of about 90 degrees or more. The nanoporous membrane separator is particularly advantageous over current porous metal vent components, because the nanoporous membrane separator is lighter and less expensive than its metal counterpart.

The terminology used herein is for the purpose of describing particular embodiments only and is not intended to be limiting of the invention. Ranges disclosed herein are inclusive and combinable (e.g., ranges of “up to about 25 wt %, or, more specifically, about 5 wt % to about 20 wt %”, is inclusive of the endpoints and all intermediate values of the ranges of “about 5 wt % to about 25 wt %,” etc.). “Combination” is inclusive of blends, mixtures, alloys, reaction products, and the like. Furthermore, the terms “first,” “second,” and the like, herein do not denote any order, quantity, or importance, but rather are used to distinguish one element from another, and the terms “a” and “an” herein do not denote a limitation of quantity, but rather denote the presence of at least one of the referenced item. The modifier “about” used in connection with a quantity is inclusive of the stated value and has the meaning dictated by context, (e.g., includes the degree of error associated with measurement of the particular quantity). The suffix “(s)” as used herein is intended to include both the singular and the plural of the term that it modifies, thereby including one or more of that term (e.g., the colorant(s) includes one or more colorants). Reference throughout the specification to “one embodiment”, “another embodiment”, “an embodiment”, and so forth, means that a particular element (e.g., feature, structure, and/or characteristic) described in connection with the embodiment is included in at least one embodiment described herein, and may or may not be present in other embodiments. In addition, it is to be understood that the described elements may be combined in any suitable manner in the various embodiments.

Unless otherwise defined, all terms (including technical and scientific terms) used herein have the same meaning as commonly understood by one of ordinary skill in the art to which the embodiments of the invention belong. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

While the disclosure has been described with reference to an exemplary embodiment, it will be understood by those skilled in the art that various changes may be made and equivalents may be substituted for elements thereof without departing from the scope of the disclosure. In addition, many modifications may be made to adapt a particular situation or material to the teachings of the disclosure without departing from the essential scope thereof. Therefore, it is intended that the disclosure not be limited to the particular embodiment disclosed as the best mode contemplated for carrying out this disclosure, but that the disclosure will include all embodiments falling within the scope of the appended claims.

1. A vent for a fuel tank comprising:
a nanoporous membrane separator positioned in an opening in a fuel tank to allow vapor from a fuel to flow across a membrane, wherein the membrane comprises a network in which surfaces of the network define a plurality of interconnecting pores extending through the membrane, wherein the plurality of interconnecting pores have a mean pore size of about 0.1 nanometers to about 50 nanometers, and are permeable to a selected one or both of fuel vapor and air, and impermeable to liquid fuel; and
an oleophobic coating disposed on surfaces of the plurality of interconnecting pores and configured to provide oleophobicity to the membrane.

2. The vent of claim 1, wherein the membrane is a cellulose acetate membrane.

3. The vent of claim 1, wherein the membrane is expanded polytetrafluoroethylene, polysulfone, polyethersulfone, polyamide, polyurethane, polyester, polyolefin, or a combination comprising at least one of the foregoing.

4. The vent of claim 1, wherein the nanoporous membrane separator has an oleophobic rating of at least 2.

5. The vent of claim 1, wherein the nanoporous membrane separator has an oleophobic rating of at least 4.

6. The vent of claim 1, wherein the nanoporous membrane separator has an oleophobic rating of at least 6.

7. The vent of claim 1, wherein the nanoporous membrane separator has an oleophobic rating of at least 8.

8. The vent of claim 1, wherein the fuel comprises ethanol, methanol, gasoline, diesel fuel, kerosene, or a combination comprising at least one of the foregoing.

9. The vent of claim 1, wherein the oleophobic coating comprises a polymer comprising fluorinated C₁₋₃₂ hydrocarbon moieties, wherein the polymer comprises units derived from polymerization of fluoro(C₁₋₁₆)alkyl acrylates, fluoro(C₁₋₁₆)alkyl methacrylates, perfluoro(C₁₋₁₆)alkyl acrylates, perfluoro(C₁₋₁₆)alkyl methacrylates, fluorinated and perfluorinated C₁₋₁₂ olefins, fluoro(C₁₋₁₂)alkyl maleic acid esters, perfluoro(C₁₋₁₂)alkyl maleic acid esters, fluoro(C₁₋₁₂)alkyl (C₆₋₁₂)aryl urethane oligomers, fluoro(C₁₋₁₂)alkyl allyl urethane oligomers, fluoro(C₁₋₁₂)alkyl urethane acrylate oligomers, fluoro(C₁₋₁₂)alkyl urethane acrylate oligomers, or a combination comprising at least one of the foregoing.

10. A fuel tank system for storing and providing fuel to a small combustion engine, the system comprising:
a fuel tank configured to hold a liquid fuel, comprising an opening for filling the tank; and
a fuel cap configured to close the opening of the fuel tank, wherein the fuel cap comprises:
a main body portion having a vent aperture formed therein;
a nanoporous membrane separator disposed in the main body portion and in fluid communication with the vent aperture, wherein the nanoporous membrane separator comprises a membrane, and the membrane comprises a network in which surfaces of the network define a plurality of interconnecting pores extending through the membrane, wherein the plurality of interconnecting pores have a mean pore size of about 0.1 nanometers to about 50 nanometers, and are permeable to a selected one or both of a fuel vapor and air, and impermeable to a liquid fuel; and
an oleophobic enhancement coating disposed on surfaces of the plurality of interconnecting pores and configured to provide oleophobicity to the membrane.

11. The fuel tank system of claim 10, wherein the membrane is a cellulose acetate membrane.

12. The fuel tank system of claim 10, wherein the membrane is expanded polytetrafluoroethylene, polysulfone, polyethersulfone, polyamide, polyurethane, polyester, polyolefin, or a combination comprising at least one of the foregoing.

13. The fuel tank system of claim 10, wherein the nanoporous membrane separator has an oleophobic rating of at least 2.

14. The fuel tank system of claim 10, wherein the nanoporous membrane separator has an oleophobic rating of at least 4.

15. The fuel tank system of claim 10, wherein the nanoporous membrane separator has an oleophobic rating of at least 6.

16. The fuel tank system of claim 10, wherein the nanoporous membrane separator has an oleophobic rating of at least 8.

17. The fuel tank system of claim 10, wherein the oleophobic coating comprises a polymer comprising fluorinated C₁₋₃₂ hydrocarbon moieties, wherein the polymer comprises units derived from polymerization of fluoro(C₁₋₁₆)alkyl acrylates, fluoro(C₁₋₁₆)alkyl methacrylates, perfluoro(C₁₋₁₆)alkyl acrylates, perfluoro(C₁₋₁₆)alkyl methacrylates, fluorinated and perfluorinated C₁₋₁₂ olefins, fluoro(C₁₋₁₂)alkyl maleic acid esters, perfluoro(C₁₋₁₂)alkyl maleic acid esters, fluoro(C₁₋₁₂)alkyl (C₆₋₁₂)aryl urethane oligomers, fluoro(C₁₋₁₂)alkyl allyl urethane oligomers, fluoro(C₁₋₁₂)alkyl urethane acrylate oligomers, fluoro(C₁₋₁₂)alkyl urethane acrylate oligomers, or a combination comprising at least one of the foregoing.

18. The fuel tank system of claim 10, wherein the nanoporous membrane separator further comprises a peripheral rim portion and a central portion, wherein the rim portion is in physical communication with the main body portion and the central portion are in fluid communication with the vent aperture.

19. A fuel tank system for storing and providing fuel to a small combustion engine, the system comprising:
a fuel tank configured to hold a liquid fuel, comprising an opening for filling the tank;
a fuel cap configured to close the opening of the fuel tank; and
a venting system disposed remote from the fuel cap in a second opening of the fuel tank, wherein the venting system is configured to provide pressure compensation to the fuel tank, the system comprising:
a housing defining a chamber in fluid communication with the second opening;
a cover disposed over and in physical communication with the housing;
a nanoporous membrane separator disposed in the housing and in fluid communication with the chamber, wherein the nanoporous membrane separator comprises a membrane, and the membrane comprises a network in which surfaces of the network define a plurality of interconnecting pores extending through the membrane, wherein the plurality of interconnecting pores have a mean pore size of about 0.1 nanometers to about 50 nanometers, and are permeable to a selected one or both of a fuel vapor and air, and impermeable to a liquid fuel; and
an oleophobic enhancement coating disposed on surfaces of the plurality of interconnecting pores and configured to provide oleophobicity to the membrane.

20. The fuel tank system of claim 19, wherein the closing further comprises a port in fluid communication with the chamber and the second opening, wherein the port further comprises a conduit connected thereto, wherein the conduit is in fluid communication with a storage canister.
